(19) United States
(12) Patent Application Publication
(10) Pub. No.: US 2025/0336115 A1
(43) Pub. Date: Oct. 30, 2025

(54) A NON-TRANSITORY MACHINE-READABLE MEDIUM, COMPUTING DEVICE, AND METHOD FOR GENERATING VISUALIZATION

(71) Applicant: Trayport Limited, London (GB)

(72) Inventors: Elliot Pickard, London (GB); Michael Alexander Cowley, London (GB)

(21) Appl. No.: 18/648,290

(22) Filed: Apr. 26, 2024

(51) Int. Cl. G06T 11/20; G06Q 40/06

(52) U.S. Cl. CPC G06T 11/206; G06Q 40/06; G06T 2200/24

(57) ABSTRACT

Disclosed is a non-transitory machine-readable medium comprising instructions that, when executed by a processor (202), cause the processor to: map a first series of datapoints (204) to a first circular sector (206); map a second series of datapoints (208) to a second circular sector (210); render the first circular sector with the first series of datapoints; and adjacent to the first circular sector, render the second circular sector with the second series of datapoints.

### TECHNICAL FIELD

The present disclosure relates to non-transitory machine-readable mediums. Moreover, the present disclosure relates to computing devices comprising non-transitory machine-readable mediums.

Furthermore, the present disclosure relates to methods.

### BACKGROUND

In the fast-paced world of financial markets, the efficient visualization of market and trading data presents a critical challenge for traders and analysts alike. The primary technical issue revolves around the constraint of limited screen space within software tools designed for data analysis. As trading desks aim to display comprehensive information necessary for informed decision-making, the struggle to accommodate this breadth of data on a single screen becomes apparent. Traditional graphical user interfaces (GUIs) often face the dilemma of either reducing the size of the displayed information, leading to loss of clarity, or resorting to the use of multiple monitors, a solution that can be both costly and cumbersome.

Current solutions often involve the presentation of market data through linear plots or graphs, aiming to condense information into manageable formats. However, the linear representations, while useful, can still demand significant scrolling or switching between the screens, hindering the seamless flow of the analysis. Current solutions use an information reduction approach that involves filtering or aggregating data, potentially discarding valuable insights in the process. Additionally, alternative display methods have been used that typically employ tiled windows, tabs, or pop-up panels to accommodate the diverse data needs. However, the alternative display methods fragments the viewing experience and introduces navigation inefficiencies. Additionally, existing radial visualization options for market data often focus on single data points or lack the flexibility to handle multiple series simultaneously, limiting their utility for comprehensive analysis.

FIG. 1 (Prior Art) is a graphical representation 100 depicting a market data visualization of a product, in terms of market prices with respect to time. FIG. 1 shows a Y axis that represents the price of a product and an X axis that represents the time period. As shown, the graphical representation 100 comprises plots 102, 104, 106, and 108 for showing different sets of data related to the product or different sets of data related to different products. As shown, the plot 102 represents how the price of the product may change with the time (such as from May 2024 to October 2025). As shown, the plot 104 represents the change in the price of the same or a different product on a yearly basis (such as from 2025-2031). Likewise, the plots 106 and the plot 108 show changing prices of two different products on a yearly basis (such as from 2024-2027). However, the graphical representation 100 becomes overwhelming as the amount of data increases and hinder the user to handle multiple plots on a predefined display screen simultaneously. Therefore, it is clear from FIG. 1 that existing tools offer glimpses of solutions, a significant gap remains in effectively and efficiently presenting rich market data within the confines of the single screen.

Therefore, in light of the foregoing discussion, there exists a need to overcome the aforementioned drawbacks.

### SUMMARY

The aim of the present disclosure is to provide a compact, radial visualization method for market and trading data, specifically designed to address the challenge of limited screen space in various software tools. The aim of the present disclosure is achieved by a non-transitory machine-readable medium comprising instructions, a computing device comprising a non-transitory machine-readable medium, and a method as defined in the appended independent claims to which reference is made. Advantageous features are set out in the appended dependent claims.

Throughout the description and claims of this specification, the words “comprise”, “include”, “have”, and “contain” and variations of these words, for example “comprising” and “comprises”, mean “including but not limited to”, and do not exclude other components, items, integers or steps not explicitly disclosed also to be present. Moreover, the singular encompasses the plural unless the context otherwise requires. In particular, where the indefinite article is used, the specification is to be understood as contemplating plurality as well as singularity, unless the context requires otherwise.

### BRIEF DESCRIPTION OF THE DRAWINGS

FIG. 1 (Prior Art) is an illustration of a graphical representation of a market data visualization of a product, in accordance with an embodiment of the present disclosure;

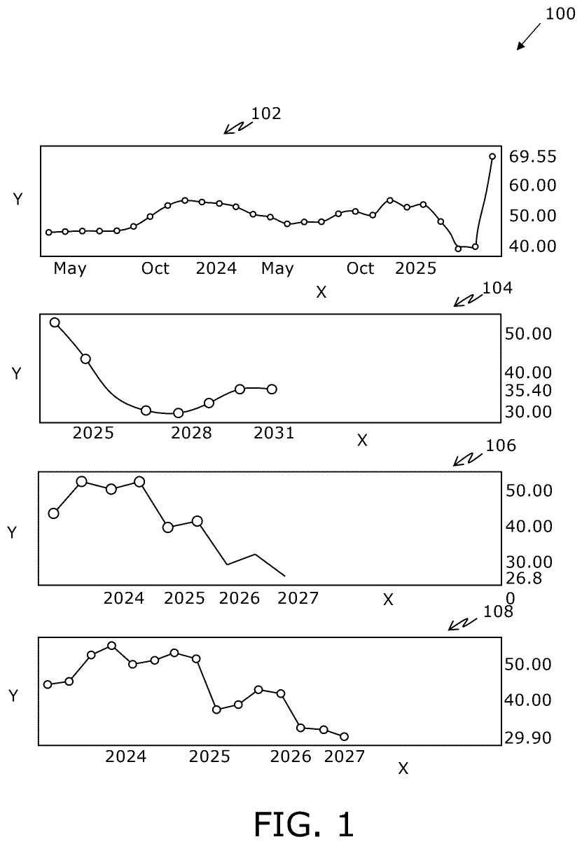

FIG. 2 is an illustration of a computing device comprising a non-transitory machine-readable medium, in accordance with an embodiment of the present disclosure; and

FIG. 3 is an illustration of a method, in accordance with an embodiment of the present disclosure.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

In a first aspect, the present disclosure provides a non-transitory machine-readable medium comprising instructions that, when executed by a processor, cause the processor to:
map a first series of datapoints to a first circular sector;
map a second series of datapoints to a second circular sector;
render the first circular sector with the first series of datapoints; and
adjacent to the first circular sector, render the second circular sector with the second series of datapoints.

The aforementioned non-transitory machine-readable medium comprises the instructions that provide a reusable blueprint for generating the radial plot, enabling its implementation across various devices and software applications. Beneficially, by directly mapping the first data point and the second data point to the first circular sector and the second circular sector, respectively, the non-transitory machine-readable medium efficiently utilizes space and visually organizes multiple data series within a compact format. This feature is crucial for accommodating dense information within limited-screen real estate. The rendering of both the first and the second circular sectors, adjacent to each other, creates the foundation of the radial plot, providing a clear and intuitive visual representation of the data. This arrangement promotes pattern recognition and comparison.

In a second aspect, the present disclosure provides a computing device comprising a non-transitory machine-readable medium of the first aspect, and a processor configured to:

map a first series of datapoints to a first circular sector;

map a second series of datapoints to a second circular sector;

render the first circular sector with the first series of datapoints; and

adjacent to the first circular sector, render the second circular sector with the second series of datapoints.

The aforementioned computing device, equipped with the instructions and the processor, translates the conceptual model into a tangible tool for practical application by the users such as traders and analysts. The processor seamlessly executes the instructions, automating the process of mapping and rendering the data points within the radial plot. The automation ensures accuracy and efficiency in visualization generation.

In a third aspect, the present disclosure provides a method comprising:
mapping a first series of datapoints to a first circular sector;
mapping a second series of datapoints to a second circular sector;
rendering the first circular sector with the first series of datapoints; and
adjacent to the first circular sector, rendering the second circular sector with the second series of datapoints.

The aforementioned method efficiently visualize market and trading data. The method enables traders and analysts to easily compare and analyze trends, patterns, and relationships between the datasets within a compact and intuitive radial plot by mapping the first series and the second series of data points to separate circular sectors and rendering the first series and the second series of data points adjacent to each other.

Throughout the present disclosure, the term “non-transitory machine-readable medium” as used herein refers to a tangible physical storage device that retains data (namely, instructions) for a significant period of time, independent of an active power source. Notably, the non-transitory machine-readable medium may include an electronic, magnetic, optical or a physical storage device that encodes instructions. Additionally, the non-transitory machine-readable may also include random access memory (RAM), read-only memory (ROM), electrically-erasable programmable read-only memory (EEPROM), flash memory, a storage drive, an optical device or the like. The non-transitory medium comprises or stores the instructions for generating the radial plot visualization.

Herein, the term “instructions” refers to a set of commands and code stored on the non-transitory machine-readable medium. Notably, the instructions may include interpretable code, bytecode, source code, and the like instructions that may undergo additional processing to be executed. The term “processor” as used herein refers to an application, program, or device that responds to requests for information or services by another application, program, process or device (such as the external device) via a network interface. Optionally, the processor also encompasses software that makes the act of serving information or providing services possible. It will be appreciated that optionally the processor includes, but is not limited to, a central processing unit (CPU), a processing core, a field-programmable gate array (FPGA), an application-specific integrated circuit (ASIC), a microprocessor, a microcontroller, a complex instruction set computing (CISC) microprocessor, a reduced instruction set computer (RISC) microprocessor, a very long instruction word (VLIW) microprocessor, or any other type of processing circuit capable of executing the instructions. Additionally, the processor and elements are arranged in various architectures for responding to and processing the instructions that execute the instructions stored in the non-transitory medium. Moreover, in case multiple processors are used, one processor may execute the instructions and the other processor may execute cooperating instructions. The non-transitory machine-readable medium and the processor are connected through the instructions stored on the medium, which, when executed by the processor, direct the processor to perform specific tasks.

Throughout the present disclosure, the term “first series of datapoints” and “second series of datapoints” as used herein refers to a set of data points that are collected, measured, or observed within a dataset to represent specific observations, measurements, or attributes of the subject. In an example, each datapoint of the first series of datapoints and the second series of datapoints includes information about a particular aspect or characteristic of the data, such as numerical values, categories, or properties.

Optionally, the first series of datapoints and the second series of datapoints represent forward curves of a financial instrument or commodity contract, environmental analysis, delivery period, derogating and/or accretive asset, bonds and any derivative representation of these. The term “forward curves” as used herein refers to a graphical representation that depicts expected future prices of a commodity (such as natural gas) over a period of time. Typically, the forward curves provide a visualization of expected changes in the future prices of the commodity over the period of time. The forward curves plot a market price against a forward or a future contract delivery date for a sequence of contract delivery dates, related to the product. The forward curves can be based on a last traded price, best bid, best ask, mid price or any other historically available scalar field. The term “financial instrument” as used herein refers to a tradable instrument or a financial contract with a monetary value. In this regard, the financial instrument may include stocks, bonds, derivatives, currencies, and the like. The term “commodity contract” as used herein refers to an agreement to buy or sell a specific quantity of the commodity (such as the energy market product) at a predetermined price at a future date. The term “environmental analysis” as used herein refers to an analysis of assessing the impact of environmental factors on business operations, investments or trading policies. Herein, the term delivery period refers to a timeframe within which the commodity or the financial instrument is delivered or settled after a contract is made. For example, in futures trading, the delivery period specifies when a buyer and a seller must fulfill their obligations to exchange the asset for cash. The term “derogating asset” as used herein refers to an asset that is experiencing a decline in value thereof over a period of time. The term “accretive asset” as used herein refers to an asset that is expected to contribute positively to the value over a period of time. The terms “bonds” as used herein refers to debt securities that represent a loan made by a trader to a borrower. Herein, the term derivative representation refers to the financial instruments whose value is derived from the value of an underlying asset, index, or rate. Examples include options, futures, and swaps, which allow the investors to speculate on or hedge against price movements in the underlying asset. Notably, the process of representation of the forward curves facilitate visual communication of complex financial and market data. Beneficially, the representation allows the traders and analysts to gain insights into the expected trends, assess risks and make informed decisions. Optionally, the shape of the forward curve can provide insights into market expectations. Optionally, the forward curve can be an upward-sloping curve, indicating an expected increase in prices over time or a downward-sloping curve, indicating an expected decrease in prices of the product.

The term “first circular sector” as used herein refers to a segment of a circular plot where the mapped data points from the first series of datapoints are visually represented. In this regard, the first circular plot is divided into various sectors and each sector represents a part of the entire visualization. The term “second circular sector” as used herein refers to another segment of the circular plot where the mapped data points from the second series of datapoints are visually represented. In this regard, the series of datapoints in the second circular sector is distinct from the datapoints of the first circular sector, which makes the second circular sector distinct from the first circular sector. Additionally, a suitable number of circular sectors, of an equal size or an unequal, may be used.

The term “map” as used herein refers to a process of establishing a relationship between the datapoints in a series and a designated segment on the circular plot. In this regard, the processor is configured to map the first series of data points to the first circular sector and the second series of data points to the second circular sector within a visual representation. This allows for a clear and organized display of two distinct datasets or aspects of the market or the trading data. Moreover, the mapping ensures that the information represented by the first series of datapoints and the second series of datapoints is visually presented with respect to the first circular plot and the second circular plot, respectively, allowing the traders to interpret and compare data efficiently. Beneficially, the visualization of the first series of datapoints and the second series of datapoints provides insights into the market or the trading data.

Optionally, the first series of datapoints or the second series of datapoints are mapped to the corresponding first circular sector or the corresponding second circular sector, respectively, with reference to at least one of: a radius of the corresponding first or second circular sector, an arc of the corresponding first or second circular sector. The term “radius” as used herein refers to a distance from a center of the circular plot to its outer boundary. The term “arc” as used herein refers to a portion of the circumference of the circular sector that defines a boundary of the circular sector. In this regard, a given series of datapoints may be positioned along the arc of a corresponding circular sector. Optionally, the first series of datapoints may be distributed along a curved boundary, providing the visual representation of the values of the market data or the trade data variation, within the first circular sector. Optionally, the second series of datapoints may be distributed along the curved boundary providing the visual representation of the other market data variation, within the second circular sector. Optionally, the mapping of the series of datapoints can happen along the radius or along the arc, or along the both, with respect to the corresponding circular sector. Moreover, the series of datapoints may be positioned based on the values, along the radius of the circular sector. Optionally, the higher values might be represented at a greater distance from the center of the circular sector and the lower values might be closer to the center of the circular sector. Moreover, the first series of datapoints and the second series of datapoints may be plotted to the same radial scale with reference to the radius of the first circular sector and the second circular sector, respectively.

The term “render” as used herein refers to a process to provide a clear and informative visual representation of the data. Once the mapping is performed, the processor then renders the first series of data points as visual elements within the first circular sector. The rendering can take various forms such as points, lines, or curves, depending on the type of data being represented. Moreover, the step of rendering allows the users, such as the traders or the analysts, to visually analyze and interpret the first series of data points more effectively than viewing raw numbers or tables. For example, the users can easily identify price movements, seasonal trends, or anomalies in the market data.

After mapping, the processor is configured to position the second circular sector next to the first circular sector within the same graphical plot. Beneficially, the visual representation of the second series of datapoints in a graphical form, is placed in the second circular sector, allowing for a side-by-side direct visual comparison between different series of datapoints and displaying the both series of datapoints in a single display screen and facilitating the analysis and interpretation of the market data (such as trading information).

Optionally, the processor is further configured to generate a radial plot comprising the first circular sector and the second circular sector rendered adjacent to the first circular sector. The term “radialplot” as used herein refers to a plot or a chart to represent data, in a circular manner. Typically, in the radial plot, the series of datapoints are plotted along the radius or along the arc, and each datapoints' position is determined by an angle and a distance from the center. Moreover, the radial plot is generated within the corresponding circular sector for easy visualization of pattern and trends in the market data. Beneficially, placing the first and second circular sectors adjacent to each other in the radial plot enables easy visual comparison between the first series of datapoints and the second series of datapoints. Additionally, the radial plots are used to represent complex data in a compact space, where the screen real estate can be a limiting factor in displaying the data. Optionally, for an example, a comparison of the radial plot to conventional X-Y plots showing the same information, the area used by the radial plot is about 14.4 units compared to an area of about 25.8 units for the conventional plots. Optionally, the radial plot uses about 56% of the area of the conventional plots.

Optionally, the processor is further configured to plot root curves of the first series of datapoints and the second series of datapoints on the corresponding first circular sector and the corresponding second circular sector, respectively. The term “root curves” as used herein refers to creating curves or lines that capture characteristics and patterns in the first series of datapoints and the second series of datapoints. In this regard, the processor is configured to use algorithms or mathematical techniques to identify and plot the root curves. The algorithm analyzes the first series of datapoints and the second series of datapoints in each series and determines the best-fit curves, that represent the trends or the patterns in the market data. Additionally, the identified root curves are plotted in the corresponding circular sectors and each point on the curve is mapped to the specific coordinates within the circular plot. Beneficially, plotting the root curves helps the users to visualize and understand the trends and patterns in the first and second series of datapoints and allows the users to assess the differences and alignment between the first series of datapoints and the second series of datapoints.

Optionally, the processor is further configured to render a value as a shaded sub-sector of the first circular sector and/or the second circular sector. The term “value” as used herein refers to an additional numerical or quantitative data such as volume of the energy market product for the delivery period. The term “shaded sub-sector” as used herein refers to a portion of the first circular sector and/or the second circular sector, used to represent the value associated with the first circular sector and/or the second circular sector. Moreover, the shaded sub-sector may be rendered in the background, behind the first series of datapoints and the second series of datapoints, within the first circular sector and the second circular sector, respectively, by the processor. Additionally, the processor renders the value by applying the assigned colors or shading to the sub-sector of the first circular sector and/or the second circular sector. Beneficially, the shaded sub-sector facilitates visually enhanced representation of the data with shaded regions indicating the associated values. The technical effect of rendering the value as the shaded sub-sector is to show two different datasets in a single circular sector and solves the trader or the analyst's need for density of information on the limited screen real estate.

Optionally, the shaded sub-sector has a same arc and a same or smaller radius compared to the corresponding first circular sector and/or second circular sector. The first circular sector consists, the first series of datapoints and the shaded sub-sector, within the same area of the arc of the first circular sector. Similarly, the second circular sector consists the second series of datapoints and the respective shaded sub-sector, within the arc of the second circular sector. Optionally, the radius of the shaded sub-sector can be the same or smaller than the radius of the corresponding first and/or second circular sector. The smaller radius of the shaded sub-sector signifies that the shaded sub-sector has lower value (such as low volume of the trade for the delivery period). Likewise, the same radius of the shaded sub-sector with the corresponding first and/or second circular sector signifies that the shaded sub-sector has higher value (such as high volume of trade for the delivery period). The technical effect of maintaining the same arc and the same or smaller radius is visual accuracy and proportional representation of the shaded sub-sector relative to the corresponding first and/or second circular sector.

Optionally, the value rendered as a shaded sub-sector of the first circular sector and/or the second circular sector is different from the first series of datapoints or the second series of datapoints. It will be appreciated that the first series of datapoints and the second series of datapoints related to the market price or the other value for a delivery period (for example seasons, months and quarters) and the like, represents a forward or a future contract delivery date. Optionally, the value rendered as the shaded sub-sector contains historical data related to the last trade price or other historically available scalar field. Moreover, the shaded sub-sector indicates an additional value, such as volume for the delivery period.

Optionally, the value rendered as a shaded sub-sector of the first circular sector and/or the second circular sector is a historical series of datapoints. The term “historical series of datapoints” as used herein refers to a series of datapoints based on last traded price, best bid, best ask, mid-price or another historically available scalar field. Moreover, the first circular sector and/or the second circular sector can additionally contain a historical curve from the same period for comparison (a shadow region). Additionally, the relative volume traded for each of the delivery periods may be shown in the background (as background shading), of the first circular sector and/or the second circular sector.

The present disclosure also relates to the computing device comprising the non-transitory machine-readable medium of the first aspect as described above. Various embodiments and variants disclosed above, with respect to the aforementioned non-transitory machine-readable medium comprising instructions, apply mutatis mutandis to the computing device comprising the non-transitory machine-readable medium of the first aspect.

The term “computing device” as used herein refers to an electronic device capable of processing, storing, and manipulating data using computational operations. Notably, the computing device may include a personal computer, a smartphone, a tablet, a laptop, a server, and the like. The computing device comprises the aforementioned non-transitory machine-readable medium, which contains instructions encoded in a non-transitory form. The instructions, when executed by the processor of the computing device, enable the computing device to perform specific tasks related to mapping and rendering the first series of data points and the second series of data points onto the first circular sector and the second circular sector, respectively. In this regard, the non-transitory machine-readable medium serves as the storage location for the instructions required to carry out the data mapping and rendering operations.

The computing device also includes the processor, which is a central component responsible for executing instructions and performing calculations. In this regard, the processor is configured to read the instructions stored in the non-transitory machine-readable medium. In an implementation, when the computing device is powered on and the instructions are accessed from the non-transitory machine-readable medium, the processor interprets and executes these instructions to carry out the mapping and rendering tasks described in the claim.

Optionally, the processor is further configured to generate a radial plot comprising the first circular sector and the second circular sector rendered adjacent to the first circular sector.

Optionally, the computing device further comprises a user interface configured to display a radial plot and a control panel comprising a plurality of series of datapoints to select from. The term “user interface” as used herein refers to an interface that encompasses elements and components through which a user interacts with a computer-related application within the computing device. Notably, the user interface includes the visual representation of the radial plot and interactive features (such as zoom controls, graphical elements or labels) designed for the user engagement. Moreover, display of the radial plot involves presenting the circular visualization of the market data on the computing device's display. The term “control panel” as used herein refers to a designed area or interface that provides the user with tools and options (such as buttons, controls or a menu) to control and customize the aspect of the displayed data. Optionally, the control panel comprises the plurality of a series of datapoints that the user can select from. Beneficially, the control panel allows the users to choose specific series of datapoints for visualization from the plurality of series of datapoints. The user interacts with the user interface through clicks, taps, and the like methods, to navigate the radial plot and make selection from the control panel. The technical effect of employing the user interface and the control panel, is to enhance the user control and customization when interacting with the radial plot. The control panel streamlines the process of selecting and switching between different series of datapoints, and facilitates efficient data analysis.

Optionally, the processor is further configured to plot root curves of the first series of datapoints and the second series of datapoints on the corresponding first circular sector and the corresponding second circular sector, respectively.

Optionally, the radial plot covers 30-70% area of the user interface. Optionally, the radial plot covers 30, 35, 40, 45, 50, 55, 60, or 65% up to 35, 40, 45, 50, 55, 60, 65 or 70% area of the user interface. It will be appreciated that by covering the aforementioned percentage of the user interface area with the radial plot, the computing device ensures an optimized use of the screen space. The radial plot, which displays the mapped data points in circular sectors, occupies a significant but not overwhelming portion of the interface. The optimized coverage prevents the radial plot from dominating the entire screen, allowing the users to view other relevant information, controls, or additional data alongside the radial plot.

The present disclosure also relates to the method as described above. Various embodiments and variants disclosed above, with respect to the aforementioned non-transitory machine-readable medium comprising instructions and the aforementioned computing device comprising a non-transitory machine-readable medium, apply mutatis mutandis to the method.

Optionally, the method further comprises generating a radial plot comprising the first circular sector and the second circular sector rendered adjacent to the first circular sector.

Optionally, the method further comprises:
deriving root curves of the first series of datapoints and the second series of datapoints; and
plotting the derived root curves of the first series of datapoints and the second series of datapoints on the corresponding first circular sector and the corresponding second circular sector, respectively.

### DETAILED DESCRIPTION OF THE DRAWINGS

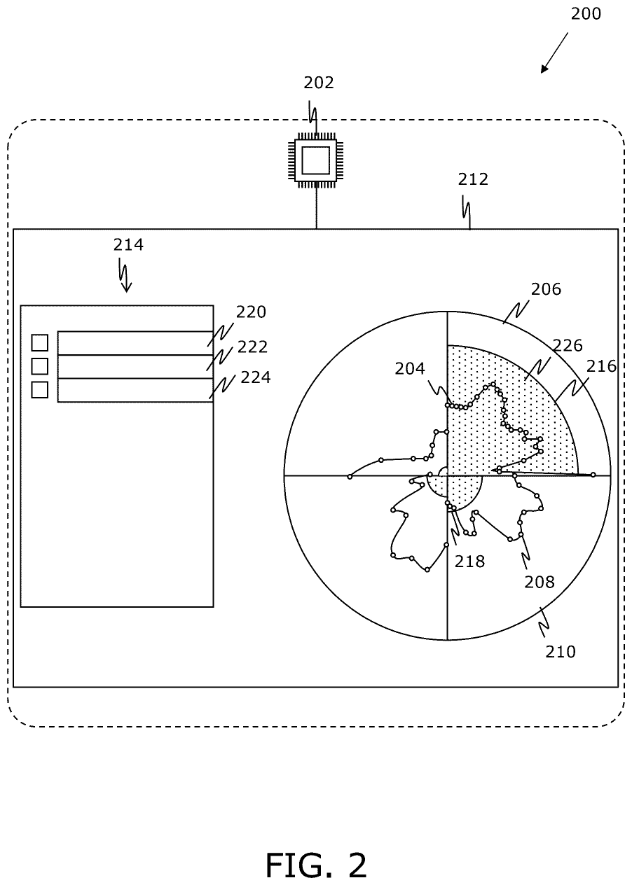

Referring to FIG. 2, illustrated is a computing device comprising a non-transitory machine-readable medium, in accordance with an embodiment of the present disclosure. As shown, the computing device 200 comprises a non-transitory machine readable medium and a processor 202 configured to map a first series of datapoints 204 (represented as dots) to a first circular sector 206 and map a second series of datapoints 208 to a second circular sector 210. Moreover, the processor 202 renders the first circular sector 206 with the first series of datapoints 204 and the second circular sector 210 with the second series of datapoints 208. As shown, the second circular sector 210 is placed adjacent to the first circular sector 206. Furthermore, the computing device 200 comprises a user interface 212 and a control panel 214. Moreover, the control panel 214 comprises various icons. As shown, a first icon 220 representing a given season, a second icon 222 representing a given year and a third icon 224 representing a given month, to show a given series of datapoints related to the given season, the given years and the given months, respectively, on the radial plot. The processor 202 is configured to render a value as a shaded sub-sector such as 216, 218 of the first circular sector 206 and/or the second circular sector 210. As shown, the value rendered as the shaded sub-sector 216, 218 of the first circular sector 206 and/or the second circular sector 210 is a historical series of datapoints 226.

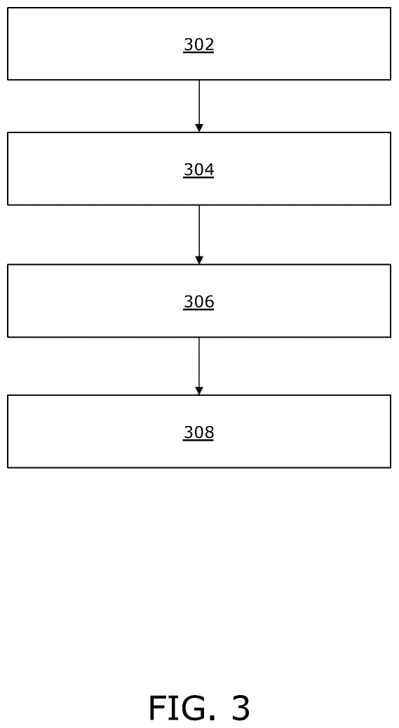

Referring to FIG. 3, illustrated is a method, in accordance with an embodiment of the present disclosure. At step 302, a first series of datapoints is mapped to a first circular sector. At step 304, a second series of datapoints is mapped to a second circular sector. At step 306, the first circular sector is rendered with the first series of datapoints. At step 308, the second circular sector is rendered with the second series of datapoints adjacent to the first circular sector.

The aforementioned steps are only illustrative and other alternatives can also be provided where one or more steps are added, one or more steps are removed, or one or more steps are provided in a different sequence without departing from the scope of the claims herein.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1. A non-transitory machine-readable medium comprising instructions that, when executed by a processor, cause the processor to:
map a first series of datapoints to a first circular sector;
map a second series of datapoints to a second circular sector;
render the first circular sector with the first series of datapoints; and
adjacent to the first circular sector, render the second circular sector with the second series of datapoints, wherein the instructions, when executed by the processor, further cause the processor to render a value as a shaded sub-sector of the first circular sector and/or the second circular sector, value being data that is different from first series of datapoints and second series of datapoints.

2. (canceled)

3. The non-transitory machine-readable medium of claim 1, wherein the shaded sub-sector has a same arc and a same or smaller radius compared to the corresponding first circular sector and/or second circular sector.

4. The non-transitory machine-readable medium of claim 1, wherein the value rendered as a shaded sub-sector of the first circular sector and/or the second circular sector is different from the first series of datapoints or the second series of datapoints.

5. The non-transitory machine-readable medium of claim 1, wherein the value rendered as a shaded sub-sector of the first circular sector and/or the second circular sector is a historical series of datapoints.

6. The non-transitory machine-readable medium of claim 1, wherein the first series of datapoints or the second series of datapoints are mapped to the corresponding first circular sector or the corresponding second circular sector, respectively, with reference to at least one of: a radius of the corresponding first or second circular sector, an arc of the corresponding first or second circular sector.

7. The non-transitory machine-readable medium of claim 1, wherein the first series of datapoints and the second series of datapoints represent forward curves of a financial instrument or commodity contract, environmental analysis, delivery period, derogating and/or accretive asset, bonds and any derivative representation of these.

8. The non-transitory machine-readable medium of claim 1, wherein the instructions, when executed by the processor, further cause the processor to generate a radial plot comprising the first circular sector and the second circular sector-rendered adjacent to the first circular sector.

9. The non-transitory machine-readable medium of claim 1, wherein the instructions, when executed by the processor, further cause the processor to plot root curves of the first series of datapoints and the second series of datapoints on the corresponding first circular sector and the corresponding second circular sector, respectively.

10. A computing device comprising a processor; and
a non-transitory machine-readable medium comprising instructions that, when executed by the processor, cause the processor to:
map a first series of datapoints to a first circular sector;
map a second series of datapoints to a second circular sector;
render the first circular sector with the first series of datapoints; and
adjacent to the first circular sector, render the second circular sector with the second series of datapoints, wherein the instructions, when executed by the processor, further cause the processor to render a value as a shaded sub-sector of the first circular sector and/or the second circular sector, value being data that is different from first series of datapoints and second series of datapoints.

11. The computing device of claim 10, wherein the non-transitory machine-readable medium further comprises instructions that, when executed by the processor, further cause the processor to generate a radial plot comprising the first circular sector and the second circular sector rendered adjacent to the first circular sector.

12. The computing device of claim 10, further comprising a user interface configured to display a radial plot and a control panel comprising a plurality of series of datapoints to select from.

13. The computing device of claim 10, wherein the non-transitory machine-readable medium further comprises instructions that, when executed by the processor, further cause the processor to plot root curves of the first series of datapoints and the second series of datapoints on the corresponding first circular sector and the corresponding second circular sector, respectively.

14. The computing device of claim 12, wherein the radial plot covers 30-70% area of the user interface.

15. A method comprising:
mapping a first series of datapoints to a first circular sector;
mapping a second series of datapoints to a second circular sector;
rendering the first circular sector with the first series of datapoints; and
adjacent to the first circular sector, rendering the second circular sector with the second series of datapoints, wherein the method further comprises rendering a value as a shaded sub-sector of the first circular sector and/or the second circular sector, value being data that is different from first series of datapoints and second series of datapoints.

16. The method of claim 15, further comprising generating a radial plot comprising the first circular sector and the second circular sector rendered adjacent to the first circular sector.

17. The method of claim 15, further comprising:
deriving root curves of the first series of datapoints and the second series of datapoints; and
plotting the derived root curves of the first series of datapoints and the second series of datapoints on the corresponding first circular sector and the corresponding second circular sector, respectively.
